(19) United States
(12) Patent Application Publication
(10) Pub. No.: US 2026/0309501 A1
(43) Pub. Date: Oct. 8, 2026

(54) METHOD AND SYSTEM FOR COMPUTING A FLIGHT PATH VECTOR

(71) Applicant: Airbus Operations (S.A.S.), Toulouse (FR)

(72) Inventors: Lilian Ronceray, Toulouse (FR); Jean Muller, Toulouse (FR); Guillaume Alix, Toulouse (FR)

(21) Appl. No.: 19/637,288

(22) Filed: Apr. 2, 2026

(30) Foreign Application Priority Data
Apr. 8, 2025 (FR) FR2503712

(51) Int. Cl. G01C 21/20; G08G 5/23

(52) U.S. Cl. CPC G01C 21/20; G08G 5/23

(57) ABSTRACT

A method for computing a flight path vector, or FPV, of an aircraft, includes applying a low-pass filter to inertial data originating from at least one inertial sensor on board the aircraft and representing an actual FPV, computing an estimate of a variation in the FPV as a function of commands provided by a pilot of the aircraft via a control stick, computing an estimate of the FPV by integrating the estimate of the variation in the FPV, applying a high-pass filter to the estimate of the FPV, and, acquiring a resulting signal by adding an output signal from the low-pass filter and an output signal from the high-pass filter, with the signal resulting from the addition being intended to be displayed as an FPV. The method allows the stability of the FPV to be further improved in the event of turbulence.

### TECHNICAL FIELD

The disclosure herein relates to a method and a system for computing a flight path vector (FPV).

### BACKGROUND

The flight path vector (FPV) is information intended to be displayed in the cockpit of the aircraft using a display system, for example, a head-up display (HUD) system. It shows the pilot the path of the aircraft resulting from the sum of all the forces acting on the aircraft. Its value is computed by flight computers on board the aircraft.

As illustrated in FIG. 3, the flight path vector (FPV) 301 is displayed as a small circular symbol representing a rear view of the aircraft. It includes a longitudinal component 302 (i.e., along the longitudinal axis of the aircraft), which is information relating to the angle of the flight path relative to the horizon (or FPA, for “Flight Path Angle”), and a lateral component 303 (i.e., along the lateral axis of the aircraft), which is information relating to drift.

It is a tool used by pilots for precisely controlling flight and navigation. It is an indicator that provides a real-time visual representation of the path of the aircraft relative to the horizon. This allows pilots to precisely monitor the attitude and the path of the aircraft during the various phases of flight, notably take-off, climbing, cruising, descending and landing.

Currently, the flight path vector (FPV) is computed based on inertial data (measurements) provided by inertial sensors. These include, for example, ADIRU (Air Data Inertial Reference Unit) type inertial sensors, included in an ADIRS (Air Data and Inertial Reference System) type inertial reference system.

The flight path vector (FPV) is computed without filtering the inertial data. Consequently, in the event of turbulence, the flight path vector becomes unstable.

The current solution for computing the flight path vector (FPV) is satisfactory, but a need exists to improve it further in order to facilitate the various phases of flight, notably landing. Notably, a need exists to further improve the stability of the flight path vector in the event of turbulence. A need also exists to further improve the responsiveness of the flight path vector to the actions of the pilot on the control stick (a conventional control stick or a mini-stick of the “joystick” type), i.e., to the commands provided by the pilot of the aircraft via the control stick.

### SUMMARY

A method is disclosed for computing a flight path vector of an aircraft, the method being implemented by a computation system on board the aircraft and comprising electronic circuitry, the method comprising:
applying a low-pass filter to inertial data originating from at least one inertial sensor on board the aircraft and representing an actual flight path vector of the aircraft;
computing an estimate of a variation in the flight path vector as a function of commands provided by a pilot of the aircraft via a control stick;
computing an estimate of the flight path vector by integrating the estimate of the variation in the flight path vector;
applying a high-pass filter to the estimate of the flight path vector; and
acquiring a resulting signal by adding an output signal from the low-pass filter and an output signal from the high-pass filter, the signal resulting from the addition being intended to be displayed, with a display system included in the aircraft, as a flight path vector of the aircraft.

Thus, the general principle of the proposed solution involves combining two complementary filtering processes:
low-pass filtering on the inertial data representing the actual flight path vector of the aircraft; this inertial data forms the initial data that the flight path vector can be computed from; this initial data is noisy due to turbulence and the low-pass filtering allows this noise to be reduced or eliminated; and
high-pass filtering on an estimate of the flight path vector itself, computed as a function of the commands provided by the pilot via the control stick; this estimate of the flight path vector forms a second datum that the flight path vector can be computed from; this second datum is affected by a static error and the high-pass filtering allows this static error to be reduced or eliminated and allows the dynamic response of this second datum to be acquired.

By adding the output signals from the two filtering processes, an estimate (computed value) of the flight path vector is acquired that reduces or eliminates the impact of turbulence, without adding delay (i.e., by retaining the dynamic response of the actual flight path vector). The proposed solution therefore allows the stability of the flight path vector (FPV) to be further improved in the event of turbulence.

According to a particular embodiment, the method comprises: displaying, with the display system included in the aircraft, the signal resulting from the addition as a flight path vector of the aircraft.

According to a particular embodiment, the method comprises:
applying a phase lead to the signal resulting from the addition, which phase lead is determined as a function of commands provided by the pilot via the control stick; and
displaying, with the display system included in the aircraft, the signal resulting from the application of the phase lead as the flight path vector of the aircraft.

According to a particular embodiment, the application of the low-pass filter, the computation of the estimate of the flight path vector, the application of the high-pass filter and the acquisition of the resulting signal are implemented:
by multiplying the estimate of the variation in the flight path vector by a time constant value of the low-pass filter;
by adding the inertial data and the data resulting from the multiplication; and
by applying the low-pass filter to the data resulting from the addition of the inertial data and the data resulting from the multiplication.

According to a particular embodiment, the computation system implementing the method is a distributed system comprising a first part hosted by the display system and a second part hosted by a primary flight control computer.

According to a particular embodiment, the method is executed, on the one hand, for a longitudinal component of the flight path vector, called flight path angle, and, on the other hand, for a lateral component of the flight path vector, called drift.

According to a particular embodiment, the execution for the longitudinal component of the flight path vector, called flight path angle, comprises: adding a correction of a lever arm effect between the at least one inertial sensor and a center of rotation of the aircraft to the inertial data, before applying the low-pass filter.

According to a particular embodiment, the execution for the longitudinal component of the flight path vector, called flight path angle, comprises: applying a correction of a ground effect experienced by the aircraft to the phase lead, before applying the phase lead to the signal resulting from the addition of the output signal from the low-pass filter and the output signal from the high-pass filter.

A computer program product is also proposed comprising instructions that cause a processor to execute the method set forth above according to any one of the embodiments thereof when the instructions are executed by the processor.

A storage medium is also proposed storing such instructions that cause the processor to execute the method set forth above according to any one of the embodiments thereof when the instructions are read from the storage medium and are executed by the processor.

A system is also proposed for computing a flight path vector of an aircraft, which system is on board the aircraft and comprises electronic circuitry configured to implement:
applying a low-pass filter to inertial data originating from at least one inertial sensor on board the aircraft and representing an actual flight path vector of the aircraft;
computing an estimate of a variation in the flight path vector as a function of commands provided by a pilot of the aircraft via a control stick;
computing an estimate of the flight path vector by integrating the estimate of the variation in the flight path vector;
applying a high-pass filter to the estimate of the flight path vector; and
acquiring a resulting signal by adding an output signal from the low-pass filter and an output signal from the high-pass filter, the signal resulting from the addition being intended to be displayed, with a display system included in the aircraft, as a flight path vector of the aircraft.

More generally, a system is proposed for computing a flight path vector, configured to execute the method set forth above, according to any one of the embodiments thereof.

An aircraft is also proposed comprising a system for computing a flight path vector, as set forth above.

### BRIEF DESCRIPTION OF THE DRAWINGS

The aforementioned features of the disclosure herein, as well as others, will become more clearly apparent upon reading the following description of at least one embodiment, with the description being provided with reference to the appended drawings, in which:

FIG. 1 schematically illustrates a side view of an aircraft equipped with a flight path vector (FPV) computation system;

FIG. 2 schematically illustrates an example of the hardware architecture of the FPV computation system of FIG. 1;

FIG. 3 schematically illustrates the flight path vector (FPV), with its longitudinal component (FPA) and its lateral component (drift);

FIG. 4 schematically illustrates the FPV computation system of FIG. 1, according to a first embodiment;

FIG. 5 schematically illustrates the FPV computation system of FIG. 1, according to a second embodiment;

FIG. 6 schematically illustrates an example of filtering, by the FPV computation system of FIG. 1, of the longitudinal component (FPA) of the FPV;

FIG. 7 schematically illustrates the FPV computation system of FIG. 1, according to a third embodiment;

FIG. 8 schematically illustrates the computation of the longitudinal component (FPA) of the FPV, with the third embodiment (that of FIG. 7) of the FPV computation system;

FIG. 9 schematically illustrates the computation of the lateral component (drift) of the FPV, with the third embodiment (that of FIG. 7) of the FPV computation system;

FIG. 10 schematically illustrates an algorithm for computing the FPV, executed by the FPV computation system of FIG. 1, according to a first embodiment; and

FIG. 11 schematically illustrates an algorithm for computing the FPV, executed by the FPV computation system of FIG. 1, according to a second embodiment.

### DETAILED DESCRIPTION

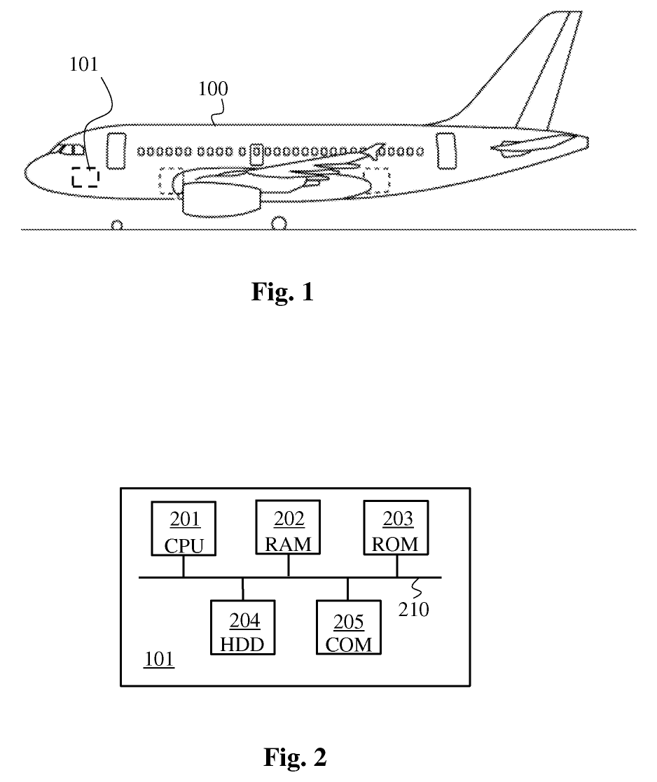

FIG. 1 schematically illustrates a side view of an aircraft 100 equipped with a system 101 for computing the flight path vector (FPV) as already described above. For the sake of simplification, this system 101 is called “FPV computation system” hereafter.

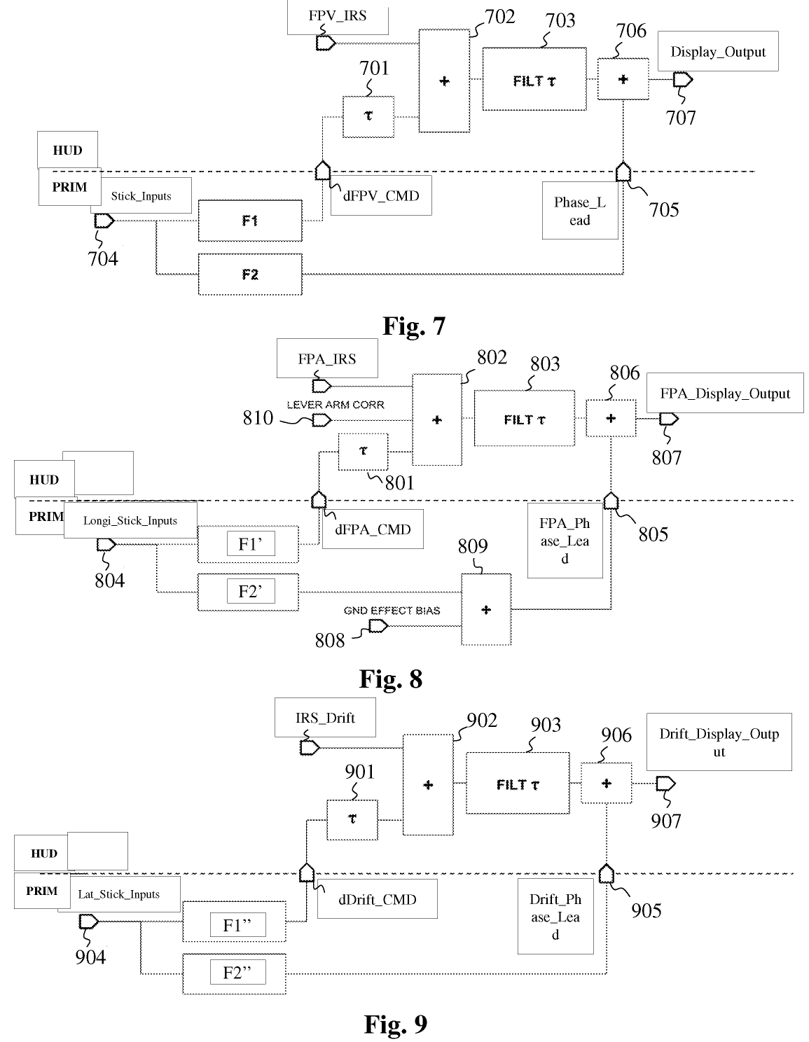

The FPV computation system 101 is electronic equipment on board the aircraft 100 and comprises electronic circuitry. For example, it forms part of electronic circuitry of the avionics of the aircraft 100. It is, for example, integrated into a computer of the aircraft 100, or is even distributed across several computers of the aircraft 100. As described hereafter (see FIG. 7), it is distributed, for example, between a head-up display (HUD) system and a primary flight control computer (PRIM).

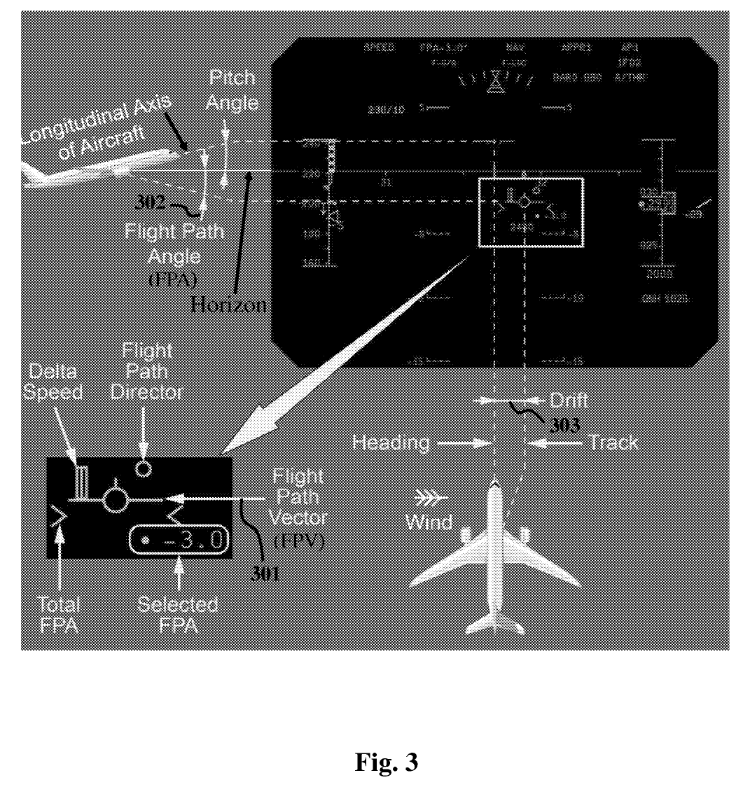

As already described above, and as illustrated in FIG. 3, the flight path vector (FPV) 301 comprises a longitudinal component 302, which is information relating to the angle of the flight path relative to the horizon (or FPA, for “Flight Path Angle”), and a lateral component 303, which is information relating to drift.

FIG. 2 schematically illustrates an example of the hardware architecture of the FPV computation system 101 of FIG. 1, which then comprises the following, connected by a communication bus 210: a processor or central processing unit (CPU) 201; a random access memory RAM 202; a read-only memory ROM 203 (for example, a flash memory); a data storage device, such as a hard disk drive (HDD), or a storage medium reader, such as a secure digital (SD) card reader 204; at least one communication interface 205 allowing the system 101 to interact with the avionics of the aircraft 100.

The processor 201 is capable of executing instructions that form a computer program and that are loaded into the RAM 202 from the ROM 203, from an external memory (not shown), from another storage medium (such as an SD card), or from a communication network (not shown). When the FPV computation system 101 is powered up, the processor 201 is capable of reading the aforementioned instructions from the RAM 202 and of executing them. When they are read (from the RAM 202 or a storage medium) and executed by the processor 201, these instructions (which form a computer program) cause the processor 201 to execute the behaviors, steps and algorithms described herein.

All or some of the behaviors, steps and algorithms described herein thus can be implemented in software form by executing a set of instructions using a programmable machine, such as a digital signal processor (DSP) or a microcontroller, or can be implemented in hardware form by a machine or a dedicated component (“chip”) or a dedicated set of components (“chipset”), such as a field-programmable gate array (FPGA) or an application-specific integrated circuit (ASIC). In general, the FPV computation system 101 comprises electronic circuitry arranged and configured to implement the behaviors, steps and algorithms described herein.

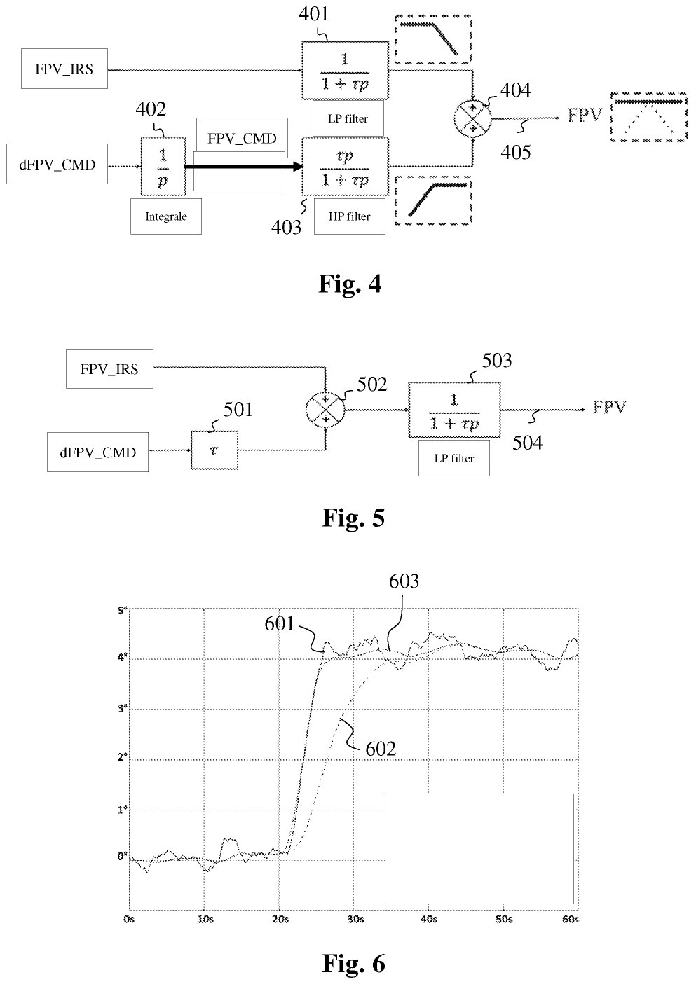

FIG. 4 schematically illustrates the FPV computation system 101 of FIG. 1, according to a first embodiment.

A first branch of the FPV computation system 101 comprises a low-pass filter 401 that receives inertial data (measurements) (reference FPV_IRS), which represents the flight path vector and is provided by inertial sensors on board the aircraft 100. These are, for example, inertial sensors of the type included in an ADIRS type inertial reference system. The low-pass filter 401 has a time constant value τ. In Laplace domain notation, it is written as: 1/(1+τ.p), with p being a Laplace variable (complex variable).

A second branch of the FPV computation system 101 comprises an integration block 402, which generates an estimate of the flight path vector (reference FPV_CMD) by integrating an estimate (reference dFPV_CMD) of a variation in the flight path vector. In Laplace domain notation, the integration block 402 is written as: 1/p, with p being the aforementioned Laplace variable. As described hereafter (see FIG. 7), the estimate dFPV_CMD is itself computed as a function of commands provided by a pilot of the aircraft 100 via a control stick. The second branch also comprises a high-pass filter 403 that receives the estimate FPV_CMD. The high-pass filter 403 has the same time constant value τ as the low-pass filter 401. In Laplace domain notation, it is written as: τ.p /(1+τ.p), with p being the aforementioned Laplace variable.

The FPV computation system 101 also comprises an addition block 404, which adds the output signals from the two filters 401 and 403 in order to generate a resulting signal 405 to be displayed, for example, by a head-up display (HUD) system included in the cockpit of the aircraft 100, as a flight path vector (FPV) of the aircraft.

Thus, the combination of the low-pass 401 and high-pass 403 filtering processes allows a flight path vector (FPV) to be acquired with good stability in the event of turbulence, without adding delay (preservation of the dynamic response).

This is shown in FIG. 6, which schematically illustrates an example of filtering, by the FPV computation system 101 of FIG. 1 (for example, according to the first embodiment of FIG. 4), of the longitudinal component (flight path angle FPA) of the FPV during a stepwise increase (in this case, from approximately 0° to 4°). The curve 601, which represents the evolution of the raw FPA signal over time, is noisy due to turbulence. On the curve 602, which represents the output signal from the low-pass filter 401, the noise has been significantly reduced but the signal has been delayed relative to the curve 601. On the curve 603, which represents the output signal from the addition block 404, the noise also has been significantly reduced (by virtue of the low-pass filter 401), but in this case the signal has not been delayed relative to the curve 601 (by virtue of the high-pass filter 403).

FIG. 5 schematically illustrates the FPV computation system 101 of FIG. 1, in a second embodiment that results from a simplification of the first embodiment of FIG. 4.

Indeed, in the second branch of the first embodiment, the combination formed by the integration block 402 and the high-pass filter 403 is written as: 1/p * τ.p /(1+τ.p), or after simplification as: τ /(1+τ.p), which translates into an implementation comprising a multiplication block by τ followed by a low-pass filter identical to that of the first branch (1/(1+τ.p)). Therefore, it is possible to use a single low-pass filter common to both branches. Thus, in the second embodiment, the FPV computation system 101 is simplified and comprises:
a multiplication block 501, which receives the estimate dFPV_CMD (estimate of the variation in the flight path vector) and multiplies it by τ (time constant value);
an addition block 502, which adds the inertial data FPV_IRS and the output signal from the multiplication block 501; and
a low-pass filter 503 (in Laplace domain notation: 1/(1+τ.p)), which receives the output signal from the addition block 502 and generates a signal 504 intended to be displayed, for example, by the aforementioned head-up display (HUD) system, as a flight path vector (FPV) of the aircraft 100.

FIG. 7 schematically illustrates the FPV computation system 101 of FIG. 1, according to a third embodiment.

As in the second embodiment, the FPV computation system 101 comprises:
a multiplication block 701 (identical to the multiplication block 501 of FIG. 5), which receives the estimate dFPV_CMD and multiplies it by τ;
an addition block 702 (identical to the addition block 502 of FIG. 5), which adds the inertial data FPV_IRS and the output signal from the multiplication block 701; and
a low-pass filter 703 (identical to the low-pass filter 503 of FIG. 5), which receives the output signal from the addition block 702.

The estimate fFPV_CMD is computed by a computation block F1, as a function of commands 704 (“Stick_Inputs”) provided by the pilot of the aircraft 100 via the control stick.

In the third embodiment, the FPV computation system 101 further comprises:
a computation block F2, configured to compute a phase lead signal 705 (“Phase_Lead”) based on the commands 704 (“Stick_Inputs”); and
an addition block 706, which adds the output signal from the low-pass filter 703 to the phase lead signal 705 and generates a signal 707 (“Display_Output”) intended to be displayed, for example, by the aforementioned head-up display (HUD) system, as a flight path vector (FPV) of the aircraft 100.

The addition of the phase lead 705 allows the responsiveness of the flight path vector (FPV) to the actions of the pilot on the control stick to be further improved, i.e., to the commands 704 provided by the pilot of the aircraft via the control stick. Thus, when the pilot moves the control stick, the display of the flight path vector (FPV) more closely corresponds to the target flight path than the actual path of the aircraft. The aim is for the flight path vector (FPV) to be set as soon as the pilot releases the stick and for the aircraft to lock onto this target.

FIG. 7 also illustrates an example of the distribution of the elements of the FPV computation system 101 between:
the head-up display (HUD) system, which includes the multiplication block 701, the addition block 702, the low-pass filter 703, and the addition block 706; and
a primary flight control computer (PRIM), which includes the computation block F1 (which computes the estimate dFPV_CMD) and the computation block F2 (which computes the phase lead signal 705).

This distribution allows a generic architecture to be acquired that is easy to deploy across various types of aircraft. The primary flight control computer (PRIM) allows the commands 704 provided by the pilot of the aircraft via the control stick to be taken into account, as well as the response of the aircraft based on flight control laws. In one embodiment, in the event of the loss of the terms (i.e., the estimate FPV_CMD and the phase lead signal 705) provided by the primary flight control computer (PRIM), the head-up display (HUD) system reverts to existing logic in order to maintain the FPV display.

In a variant of the implementation, the FPV computation system 101 is fully contained within the primary flight control computer (PRIM), and the head-up display (HUD) system is used solely for displaying the computed flight path vector (FPV).

FIG. 8 schematically illustrates the computation of the longitudinal component (FPA) of the FPV, using the third embodiment (that of FIG. 7) of the FPV computation system 101.

The longitudinal component of the FPV is information relating to the angle of the flight path (or FPA, for Flight Path Angle) relative to the horizon.

The architecture of the system for computing the longitudinal component FPA is directly derived from that described above, in relation to FIG. 7, for computing the flight path vector (FPV). Thus, elements 801, 802, 803, 806, F1’ and F2’ of FIG. 8 respectively correspond to elements 701, 702, 703, 706, F1 and F2 of FIG. 7. Similarly, the “Longitudinal_Stick_Inputs” (804), dFPA_CMD, FPA_IRS, FPA_Phase_Lead” (805) and “FPA_Display_Output” (807) signals of FIG. 8 correspond to the “Stick_Inputs” (704), dFPV_CMD, FPV_IRS, Phase_Lead” (705) and “Display_Output” (707) signals of FIG. 7.

It is assumed that the FPA measurement provided by the ADIRS type inertial reference system is biased by two factors:
the lever arm between the inertial sensors and the center of rotation of the aircraft; and
the ground effect experienced by the aircraft.

In order to take into account these two biases, the system for computing the longitudinal component FPA includes:
at the input of the addition block 802 (i.e., before applying the low-pass filter 806), an additional signal 810 (“LEVER ARM CORRECTION”) for correcting the lever arm effect; and
an additional signal 808 (“GND EFFECT BIAS”) for correcting the ground effect, which is added (by virtue of an addition block 809) to the phase lead signal “Phase_Lead_FPA” (805), before the latter is applied via the addition block 806.

FIG. 9 schematically illustrates the computation of the lateral component (drift) of the FPV, using the third embodiment (that of FIG. 7) of the FPV computation system 101.

The lateral component of the FPV is information relating to drift, i.e., the angle between the heading and the track, as illustrated in FIG. 3.

It is assumed that the drift measurement provided by the ADIRS type inertial reference system has no bias.

The architecture of the system for computing the lateral component (drift) is directly derived from that described above, in relation to FIG. 7, for computing the flight path vector (FPV). Thus, elements 901, 902, 903, 906, F1’’ and F2’’ of FIG. 9 respectively correspond to elements 701, 702, 703, 706, F1 and F2 of FIG. 7. Similarly, the “Lat_Stick_Inputs” (904), dDrift_CMD, Drift_IRS, Phase_Lead_Drift” (905) and “Drift_Display_Output” (907) signals of FIG. 9 correspond to the “Stick_Inputs” (704), dFPV_CMD, FPV_IRS, Phase_Lead” (705) and “Display_Output” (707) signals of FIG. 7.

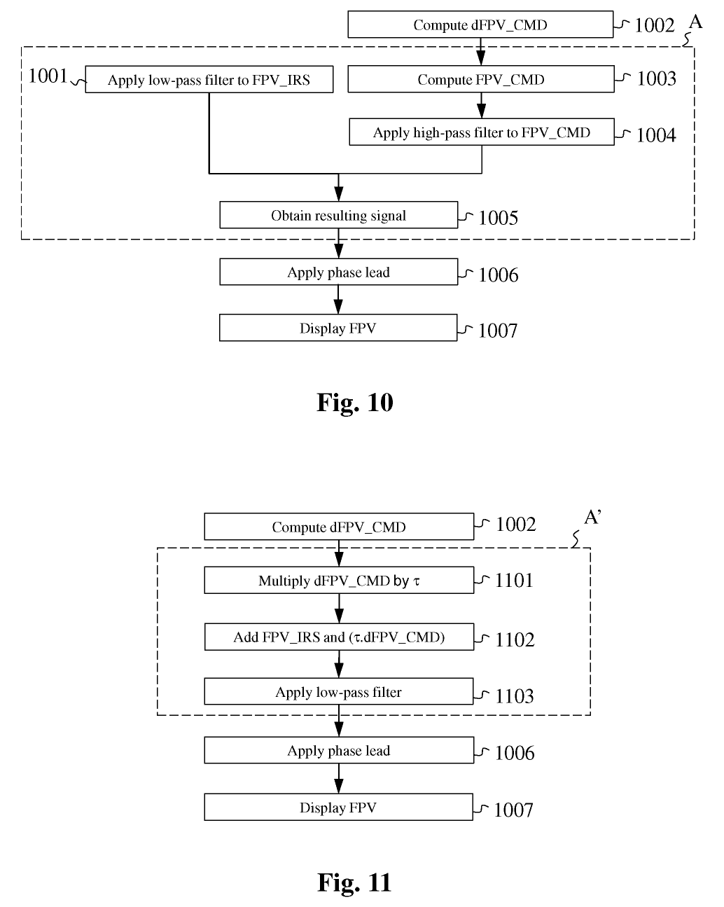

FIG. 10 schematically illustrates an FPV computation algorithm, executed by the FPV computation system 101 of FIG. 1, according to a first embodiment.

In a step 1001, the FPV computation system 101 applies the low-pass filter 401 to the inertial data FPV_IRS originating from the inertial sensors on board the aircraft and representing the actual flight path vector of the aircraft.

In a step 1002, the FPV computation system 101 computes the estimate dFPV_CMD of a variation in the flight path vector as a function of the commands provided by the pilot of the aircraft via the control stick.

In a step 1003, the FPV computation system 101 computes the estimate FPV_CMD of the flight path vector by integrating the estimate dFPV_CMD.

In a step 1004, the FPV computation system 101 applies the high-pass filter 403 to the estimate FPV_CMD.

In a step 1005, the FPV computation system 101 acquires a resulting signal by adding the output signal from the low-pass filter (401) and the output signal from the high-pass filter (403).

In a step 1006, the FPV computation system 101 applies a phase lead to the signal resulting from the addition (step 1005), which phase lead is determined as a function of the commands provided by the pilot via the control stick.

In a step 1007, the FPV computation system 101 displays, with the head-up display (HUD) system, the signal resulting from the application of the phase lead as a flight path vector (FPV) of the aircraft.

FIG. 11 schematically illustrates an FPV computation algorithm, executed by the FPV computation system 101 of FIG. 1, according to a second embodiment.

The algorithm of FIG. 11 differs from that of FIG. 10 in that steps 1001, 1003, 1004 and 1005 (forming a set of steps denoted A) are replaced by steps 1101, 1102, and 1103 (forming a set of steps denoted A’).

In a step 1002, the FPV computation system 101 computes the estimate dFPV_CMD.

In a step 1101, the FPV computation system 101 multiplies the estimate dFPV_CMD (from step 1002) by the time constant value τ of the low-pass filter 503.

In step 1102, the FPV computation system 101 adds the inertial data FPV_IRS and the data resulting from the multiplication in step 1101.

In step 1103, the FPV computation system 101 applies the low-pass filter 503 to the data resulting from the addition in step 1102.

In step 1006, the FPV computation system 101 applies the phase lead to the signal resulting from step 1103.

In step 1007, the FPV computation system 101 displays, with the head-up display (HUD) system, the signal resulting from step 1006 as a flight path vector (FPV) of the aircraft.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or "comprising" do not exclude other elements or steps, the terms "a", “an” or "one" do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for computing a flight path vector of an aircraft, the method being implemented by a computation system on board the aircraft and comprising electronic circuitry, the method comprising:
applying a low-pass filter to inertial data originating from at least one inertial sensor on board the aircraft and representing an actual flight path vector of the aircraft;
computing an estimate of a variation in the flight path vector as a function of commands provided by a pilot of the aircraft via a control stick;
computing an estimate of the flight path vector by integrating the estimate of the variation in the flight path vector;
applying a high-pass filter to the estimate of the flight path vector; and
acquiring a resulting signal by adding an output signal from the low-pass filter and an output signal from the high-pass filter, the signal resulting from the addition being intended to be displayed, with a display system included in the aircraft, as a flight path vector of the aircraft.

2. The method according to claim 1, comprising:
displaying, with the display system included in the aircraft, the signal resulting from the addition as a flight path vector of the aircraft.

3. The method according to claim 1, comprising:
applying a phase lead to the signal resulting from the addition, which phase lead is determined as a function of commands provided by the pilot via the control stick; and
displaying, with the display system included in the aircraft, the signal resulting from the application of the phase lead as a flight path vector of the aircraft.

4. The method according to claim 1, wherein applying the low-pass filter, computing the estimate of the flight path vector, applying the high-pass filter and acquiring the resulting signal are implemented:
by multiplying the estimate of the variation in the flight path vector by a time constant value of the low-pass filter;
by adding the inertial data and the data resulting from the multiplication; and
by applying the low-pass filter to the data resulting from the addition of the inertial data and the data resulting from the multiplication.

5. The method according to claim 1, wherein the computation system implementing the method is a distributed system comprising a first part hosted by the display system and a second part hosted by a primary flight control computer.

6. The method according to claim 1, wherein the method is executed for a longitudinal component of the flight path vector, or flight path angle, and for a lateral component of the flight path vector, or drift.

7. The method according to claim 6, wherein the execution for the longitudinal component of the flight path vector, or flight path angle, comprises:
adding a correction of a lever arm effect between the at least one inertial sensor and a center of rotation of the aircraft to the inertial data, before applying the low-pass filter.

8. The method according to claim 6, comprising:
applying a phase lead to the signal resulting from the addition, which phase lead is determined as a function of commands provided by the pilot via the control stick; and
displaying, with the display system included in the aircraft, the signal resulting from the application of the phase lead as a flight path vector of the aircraft;
wherein the execution for the longitudinal component of the flight path vector, or flight path angle, comprises:
applying a correction of a ground effect experienced by the aircraft to the phase lead, before applying the phase lead to the signal resulting from the addition of the output signal from the low-pass filter and the output signal from the high-pass filter.

9. A computer program product comprising instructions that cause a processor to execute the method according to claim 1 when the instructions are executed by the processor.

10. A storage medium storing a computer program comprising instructions that cause a processor to execute the method according to claim 1 when the instructions are read from the storage medium and are executed by the processor.

11. A system for computing a flight path vector of an aircraft, the system being on board the aircraft and comprising electronic circuitry configured to implement:
applying a low-pass filter to inertial data originating from at least one inertial sensor on board the aircraft and representing an actual flight path vector of the aircraft;
computing an estimate of a variation in the flight path vector as a function of commands provided by a pilot of the aircraft via a control stick;
computing an estimate of the flight path vector by integrating the estimate of the variation in the flight path vector;
applying a high-pass filter to the estimate of the flight path vector; and
acquiring a resulting signal by adding an output signal from the low-pass filter and an output signal from the high-pass filter, the signal resulting from the addition being intended to be displayed, with a display system included in the aircraft, as a flight path vector of the aircraft.

12. An aircraft comprising the system for computing a flight path vector according to claim 11.
